(19) United States
(12) Patent Application Publication
(10) Pub. No.: US 2019/0299128 A1
(43) Pub. Date: Oct. 3, 2019

(54) METHODS AND SYSTEMS FOR TREATING DRILLING FLUIDS

(71) Applicant: Schlumberger Technology Corporation, Sugar Land, TX (US)

(72) Inventors: Babak Bob Arefi, Spring, TX (US); Michael Joling, Bridgeville, PA (US); Vidya Raja, Fulshear, TX (US); Jacques Orban, Katy, TX (US)

(21) Appl. No.: 15/941,718

(22) Filed: Mar. 30, 2018

(51) Int. Cl. B01D 21/00; E21B 21/06; F28D 7/00; B01D 21/26; B01D 21/34; B01D 21/24; B01D 21/28

(52) U.S. Cl. CPC B01D 21/009; E21B 21/065; F28D 7/00; B01D 21/262; B01D 21/2494; B01D 21/2405; B01D 21/2488; B01D 21/283; B01D 21/34

(57) ABSTRACT

A mud cleaning system may include a system inlet carrying mud from a wellbore, a heater, a fluid separating system, and a system outlet carrying the mud to a holding vessel. The system inlet, the heater, the separator, and the system outlet may be fluidly connected such that mud flows from the system inlet, into the heater and the separator, and then out the system outlet.

### BACKGROUND

Drilling mud used in downhole operations is cleaned after use and then reused. A primary goal of cleaning drilling mud is to remove particulates of varying sizes that become suspended in the drilling mud while it is downhole. These particulates may include drill cuttings, the solid formation materials created during drilling of the borehole and removed therefrom by the drilling mud.

Existing mud cleaning systems cannot remove all particulates from drilling mud, but rather are limited by the smallest particulates they are able to remove. For example, one existing system is not capable of removing particulates smaller than six microns from drilling mud. If particulates cannot be removed from drilling mud by a mud cleaning system, there is no alternative method for removing them. Instead, the used drilling mud must be diluted with unused drilling mud to achieve an acceptable concentration of particulates. Diluting used drilling mud with unused drilling mud increases the total amount of drilling mud that must be made and used by decreasing the amount of used drilling mud that may be used for each drilling operation. This may increase operational costs and have a negative environmental impact.

### SUMMARY OF THE DISCLOSURE

In one aspect, this disclosure relates to a mud cleaning system may include a system inlet carrying mud from a wellbore, a heater, a fluid separating system, and a system outlet carrying the mud to a holding vessel. The system inlet, the heater, the separator, and the system outlet may be fluidly connected such that mud flows from the system inlet, into the heater and the separator, and then out the system outlet.

In another aspect, this disclosure relates to a method of cleaning drilling mud, which may include the following steps: flowing the drilling mud out of a wellbore, heating the drilling mud, and separating particulates from the heated drilling mud in a fluid separation system.

In another aspect, this disclosure relates to a method of assembling an enhanced mud cleaning system, which may include attaching a recirculation system and a heater to a mud cleaning system comprising a fluid separation system. The recirculation system may feed mud output from the separator back into the fluid separation system, and the heater may heat mud being fed into the fluid separation system.

Other aspects and advantages will be apparent from the following description and the appended claims.

### BRIEF DESCRIPTION OF DRAWINGS

FIG. 1 is a cross-section view of a conventional mud cleaning system.

FIG. 2 is a cross-section view of a mud cleaning system associated with MPD operation.

FIG. 3 is a schematic view of a mud cleaning system including a heat recovery from the rig engine cooling system.

FIG. 4 is a schematic view of a mud cleaning system including a heat recovery from the rig engine exhaust gas system.

FIG. 5 is a schematic view of a mud cleaning system including a mud heating system for parallel mud processing.

FIG. 6 is a schematic view of a mud cleaning system including a heat a mud heating system for parallel mud processing system.

FIG. 7 is a schematic view of a mud cleaning system including a heat transfer system for heat cross-flow.

FIG. 8 is partial view of a mud tank for improved mud cooling.

FIG. 9 is a schematic view of a mud cleaning system.

FIG. 10 is a schematic view of a recirculation system.

FIG. 11 is a Y-adaptor for a recirculation system.

FIG. 12 is a sump for a recirculation system.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

In one aspect, the present disclosure relates to a mud cleaning system including a system inlet carrying mud from a wellbore, one or more heaters, one or more particle separators, and a system outlet carrying the mud to a holding vessel. Drilling mud may flow through the system inlet, the heater, the separator, and the system outlet sequentially. The one or more separators may include one or more shale shakers, one or more desanders, one or more desilters, one or more poor boy separators, and one or more centrifuges. If the mud cleaning system includes more than one separator, the separators may be arranged such that the mud first flows through the separator which removes the largest particulates and then through separators which remove increasingly small particles. In other words, the mud may flow through the poor boy separator(s), the shale shaker(s), the desander(s), the desilter(s), and the centrifuge(s) sequentially; however, it is also envisioned that various systems may omit one or more of such separators. The one or more heaters may heat the mud entering one or more of the separators. Heating the mud entering a separator may improve the performance of the separator by enabling the separator to remove more particulates and smaller particulates from the drilling mud, as well as gas separation through the poor boy gas separator. The separation improvement may be obtained via the reduction of the fluid viscosity.

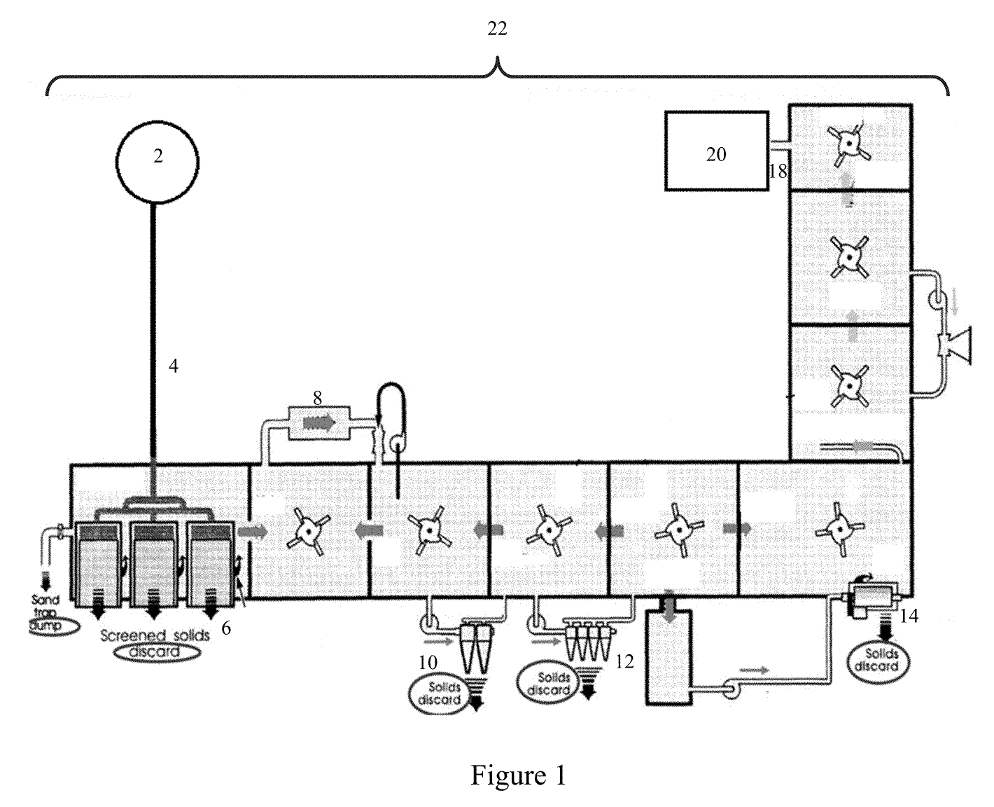

FIG. 1 shows a mud cleaning system according to one embodiment. The drilling mud enters the mud cleaning system 22 from a wellbore 2 through the flow-line 4. The drilling mud may pass through one or more gumbo removal devices (not shown). The gumbo removal devices may remove particulates having large sticky agglomerated mud and solid which may be several inches of size. The drilling mud may pass through one or more shale shakers 6. The shale shakers 6 may remove larger particulates such as drill cuttings having a particle size larger than 65 microns. The drilling mud may then flow through a degasser 8 which removes gasses from the drilling mud. Removing gasses from the drilling mud may improve the safety of the overall operation. It may also improve the function of later portions of the mud cleaning system 22. The drilling mud may flow through a mud cleaner (not shown). The mud cleaner may remove particulates having a particle size greater than 55 microns. The drilling mud then flows through a desander 10 which removes sand from the drilling mud. The desander 10 may remove particulates having a particle size greater than 40 microns. The drilling mud then flows through a desilter 12 which removes silt from the drilling mud. The desilter may remove particulates having a particle size greater than 20 microns. The particulates remaining in the drilling mud after it passes through the shale shakers 6, the desander 10, and the desilter 12 may generally be referred to as colloids. The drilling mud then flows through a centrifuge 14 which may remove some of the colloids from the drilling mud. Chemicals may be added to the drilling mud after the drilling mud exits the centrifuge. The drilling mud then exits the mud cleaning system 22 through a system outlet 18 and flows into a holding vessel 20. In one or more embodiments, the fluid may be heated prior to entering, as entering, or while in one or more of shale shaker 6, degasser 8, desander 10, desilter 12, or centrifuge 14.

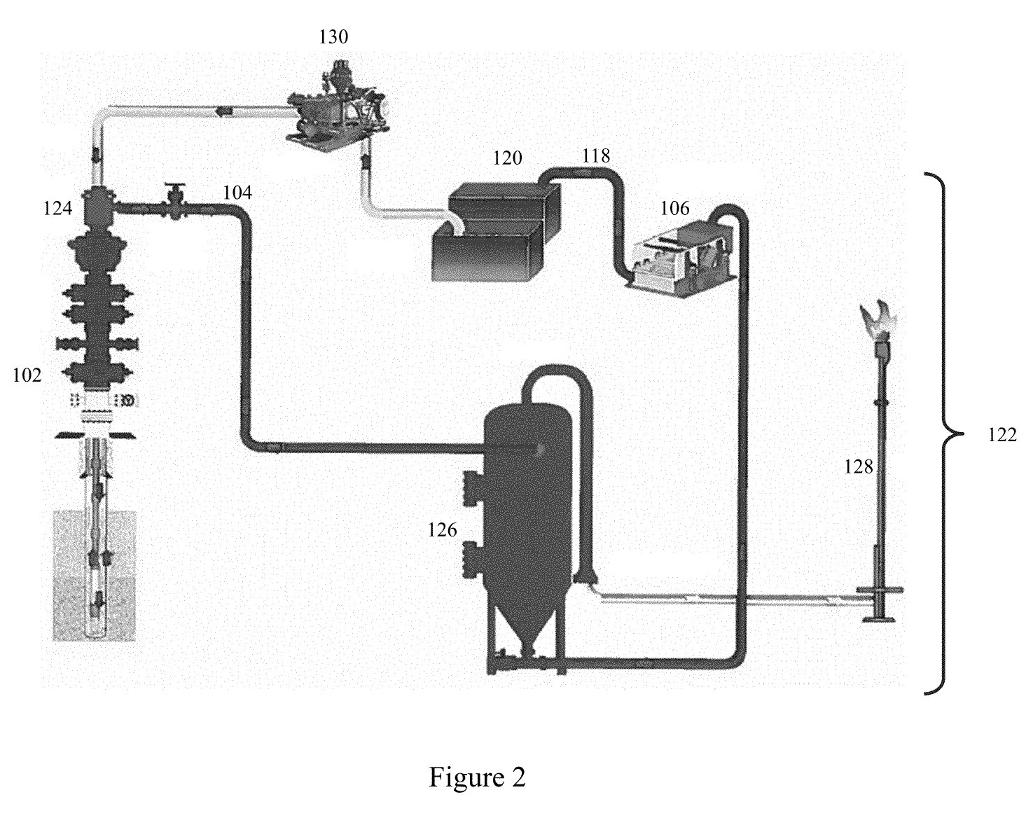

FIG. 2 shows another example of a mud cleaning system adapted to MPD (managed-pressure drilling). The drilling mud enters the mud cleaning system 122 from a wellbore 102 through a flow-out line 104. A rotating flow head 124 may control flow of the drilling mud out of the wellbore 102. A valve system 125 and choke (not shown) may be installed along the flow-out line 104. Such choke allows to control the pressure in the annulus of the well. The drilling mud may pass through a poor boy separator 126, also referred to as a mud gas separator. The poor boy separator 126 may separate gas components from the remaining phases of the drilling mud. Gas from the drilling mud may flow into a flare 128 where it may exit the mud cleaning system 122. The drilling mud may then flow into shale shakers 106 (and subsequently into one or more separators such as those described in FIG. 1). Poor boy separator 126 is used when fair amount of gas may be expected in the mud and it processes the entire flow of mud coming out of the well. The gas separator 8 of FIG. 1 is being used when limited amount of gas is expected coming out of the well: Such gas separator 8 processes only a small flow rate parallel to the main cleaning process.

The shale shakers 106 may remove particulates from the drilling mud. The drilling mud may then exit the mud cleaning system 122 through a system outlet 118 and flow into a holding vessel 120. A rig pump 130 may pump drilling mud from the holding vessel 120 to the wellbore 102. Such a mud cleaning system may be used when performing managed pressure drilling, under balanced drilling, or well control. In one or more embodiments, the fluid may be heated prior to entering, as entering, or while in one or more of poor boy separator 126, shale shaker 106, and any other separator included in mud cleaning system.

In some embodiments, the mud cleaning system of the present disclosure may include some or all of the components shown in FIG. 1, some or all of the components shown in FIG. 2, or a combination of some or all of the components shown in FIG. 1 and FIG. 2. The mud cleaning system of the present disclosure may be used to clean drilling mud that has been used in any wellbore operation, including managed pressure drilling, under balanced drilling, well control, and any other wellbore operation known in the art.

In some embodiments, the one or more heaters may be in line with one or more separators. In such embodiments, the one or more heaters may surround the separators or be built into the outer housing of the separators. The one or more heaters may heat drilling mud inside the separator. Heating may occur before separation, during separation, or both before and during separation. The amount of heat provided may be constant or may vary over the course of the separation process.

The behavior of particles in a fluid, including particulates in drilling mud, is governed by Stoke's Law. The movement of particulates within the drilling mud is a basic element of operation for separators in a mud cleaning system. Stoke's Law is given by the following equation:

$${u}_{τ} = \sqrt{\frac{4 g {d}_{p} ( {ρ}_{p} - ρ )}{3 ρ {C}_{D}}}$$

where uₜ=Terminal settling velocity; dₚ=Particle diameter; ρₚ=Density of particle; ρ=Density of fluid; g=Acceleration due to gravity; and C_{D}=Drag coefficient.

Drag coefficient, C_{D}, may be calculated using the following equation:

$${F}_{D} = \frac{{C}_{D} {A}_{p} {pu}^{2}}{2}$$

where Aₚ=Flow area; u=Flow velocity; C_{D}=Drag coefficient; and F_{D}=Drag force.

A particle moving through a fluid in a container experiences three forces acting on it that govern the velocity of the particle. Gravity acts downwards, buoyancy acts upwards, and drag force acts upwards. Eventually, a particle reaches the terminal velocity, uₜ, determined by Stoke's Law, and continues moving at that velocity until the particle reaches the bottom of the container. Stoke's Law shows how the terminal velocity of a particle is dependent on the particle diameter, the density of the particle, the density of the fluid, and the drag coefficient. The terminal velocity of a particle in a fluid may be changed by modifying either a property of the fluid or a property of the particle. The drag force equation shows how the drag force acting on a particle is dependent on the size of the particles the flow velocity with which the fluid is moving relative to the particle, and the drag coefficient, which depends mainly on the shape of the particle. The drag force acting on a particle in a fluid may also be changed by modifying properties of the particle or the fluid.

Reynolds number is a measure of flow conditions, such that laminar flow dominates at low Reynolds numbers and turbulent flow dominates at high Reynolds numbers. The drag coefficient depends on the Reynolds number. For low Reynolds number (lower than 0.1), the drag coefficient is related to Reynold number as:

C_{D}=24/Re.

When drilling mud with particulates moves in a separator, the Reynolds number is generally less than 0.1. In these conditions, Stoke's Law and the drag force equation may be rewritten as follows:

$${u}_{τ} = \frac{g {d}_{p}^{D} ( {ρ}_{p} - ρ )}{18 μ}$$

$${F}_{D} = 3 {πμμ}_{t} {d}_{p}$$

where μ=Viscosity of fluid.

In a separation process of a mud cleaning system, it is desired to increase the terminal velocity of particulates moving through drilling mud and to decrease the drag force acting on the particulates. Increasing the terminal velocity decreases the time needed for particulates to reach the bottom (or the specific extraction wall) of the separation system where they may be removed from the drilling mud. In this way, the number of particulates that reaches the bottom of the separation system during the time that the drilling mud is in the separation system may be increased.

Decreasing the viscosity of the drilling mud in a separator increases the terminal velocity of particulates moving through the drilling mud and decreases the drag force acting on the particulates. Decreasing the viscosity of drilling mud may thereby improve the performance of a separation by enabling the separation system to remove more particulates and smaller particulates from the drilling mud.

It should be understood that the direction of the movement of a particulate in the fluid depends on the main direction of the applied force. In the case of a centrifuge, the radial acceleration is typically quite large, so that the gravity effect may be neglected. In such case, the terminal velocity is radial.

In separation processes, the fluid yield value affects the separation of small particles. In the case of sedimentation, there is a threshold for particle movement, corresponding to the shear force at which the particulate surface equals the weight effect.

$$π {d}_{S}^{2} {τ}_{g} = ( {ρ}_{s} - {ρ}_{f} ) g ( \frac{1}{6} π {d}_{S}^{3} ) . \\ {τ}_{g} = \frac{{d}_{s}}{6} ( {ρ}_{s} - {ρ}_{f} ) g$$

As shown by the relationship between the smallest particle diameter, Dₚ, that a centrifuge can remove from drilling mud and properties of the drilling mud, the centrifuge, and the particulates:

$${D}_{p} = \begin{matrix}8.28 {Y}_{s} \\ a ( {ρ}_{s} - {ρ}_{f} )\end{matrix} \vert \sqrt{{\{ \begin{matrix}8.28 {Y}_{s} \\ a ( {ρ}_{s} - {ρ}_{f} )\end{matrix} \}}^{2}} \vert \begin{matrix}18 K {{Q}_{f} ( {μ }_{f} )}_{p} \\ π {L}_{pool} ( ϕ - {H}_{pool} ) a ( {ρ}_{s} - {p}_{f} )\end{matrix}$$

where ρₛ=particulate density; ρ_{f}=drilling mud density; Yₛ=drilling mud yield stress, (μ_{f})ₚ=drilling mud viscosity; K=centrifuge dependent constant; Q_{f}=centrifuge feed flow rate; Lₚₒₒₗ=centrifuge pool length; φ=centrifuge inside bowl diameter; Hₚₒₒₗ=centrifuge bowl depth; and a=centrifuge acceleration.

This equation shows how lowering the drilling mud viscosity, (μf)ₚ, lowers the smallest particle diameter, Dₚ, of particulates that a centrifuge can remove from drilling mud.

Increasing the temperature of both water based drilling mud and oil based drilling mud, up to about 100° C. decreases the viscosity of the drilling mud. However, increasing the temperature beyond that point may not significantly affect the viscosity. Heating the mud beyond that point may not have any adverse effects. Increasing the temperature of drilling mud up to 100° C. may also decrease the yield point and the internal surface tension of the drilling mud. Yield point is a measure of the ability of the drilling mud to carry drilling cuttings, and internal surface tension is a measure of the adhesion between the drilling mud and the particulates. Therefore, during cleaning, it is desired that the drilling mud have a low yield point and a low internal surface tension. Thus, heating drilling mud before it enters a separator in a mud cleaning system can increase the amount of particulates and decrease the smallest size of particulates that can be removed from the drilling mud by the separator by decreasing the viscosity, yield point, and internal surface tension of the mud in which the particulates are suspended. Heating drilling mud before it enters a separator may also allow the adsorption and absorption of particulates to be optimized.

In a separator such as a desander, a desilter, or a centrifuge, fluid is set in rotation when passing through the separator. The rotation creates a centrifugal effect which separates the heavier particulates from the lighter drilling fluid. The separation of the particulates from the drilling fluid is affected by the viscosity of the drilling fluid. The fluid rotation in the vortex formed by the rotating fluid is higher at lower viscosity. Higher fluid rotation may lead to higher centrifugal separation. The drag on the particulates is lower at lower viscosity. Lower drag on particulates may lead to faster separation. Lower viscosity of the fluid may also lead to lower mechanical load applied to the separator itself, reducing wear and tear.

The mud cleaning system of the present disclosure may be installed on a drilling rig. Installation on a drilling rig may allow the mud cleaning system to be used to clean mud used in downhole operations on that drilling rig without having to transport the mud before cleaning. The cleaning device may be installed on a skid and kept within the vicinity of the walking central package of the drilling rig.

Reduced viscosity may also help the performance of the shale shaker. Mud may separate more easily from the cuttings under the vertical acceleration imposed to the cuttings by the shaker sieves. Also, the risk of overflow at the extremity of the sieve is reduced as the mud can pass better through the shaker sieve.

The mud cleaning system of the present disclosure may include a heater that heats the drilling mud before the drilling mud enters the centrifuge (or any other separation system such as separator, desillter, desander, shale-shaker). The heater may be any type of heater known in the art. For example, the heater may be a heating element disposed inline with the system inlet and the separator. In some embodiments, the heater may heat the drilling mud to 5° C.-120° C. In some embodiments, the heater may heat the drilling mud to 60° C.-105° C. In some embodiments, the heater may heat the drilling mud to 65° C.-85° C. In one or more embodiments, the drilling mud may be an oil based mud, and the heater may heat the drilling mud to a temperature less than about 85° C. The upper limit of the desired temperature range of oil based drilling mud may be related to the flash-point of the oil based mud. The drilling mud may be a water based mud and the heater may heat the drilling mud to a temperature less than about 80° C. The upper limit of the desired temperature range for water based mud may be related to the ebullition of the water based mud and the evaporation of water from the water based mud. The temperature to which the heater heats the mud may be determined by choosing a temperature at which the viscosity, yield point, and internal surface tension of the drilling mud and the adsorption or absorption of particulates are optimized. The temperature to which the heater heats the mud may also be chosen to ensure the mud remains stable and safe. In some embodiments, the centrifuge may operate at a flow rate of 25-200 gallons per minute. In some embodiments, the centrifuge may operate at a flow rate of 50-100 gallons per minute.

In one or more embodiments, the heater may be a heat exchange system. The heat exchange system may transfer heat from a drilling rig engine, for example, to the drilling mud before the drilling mud enters a centrifuge (or other separator). In some embodiments, the drilling rig on which the mud cleaning system is disposed may need 3500 HP during drilling. This 3500 HP may correspond to 2573 KW. This power may be provided by the rig alternators which may be driven by large diesel engines (such as the Caterpillar 3512C Diesel engine). To account for the efficiency of the drilling rig components, the diesel engines may have to generate a total 3250 KW. To deliver such power, the drilling rig may require three to four large engines in operation. The efficiency of these engines may be in the range of 30% to 40%. Thus, the engines may generate up to 7500 KW of heat. Part of this heat may be transferred to the drilling mud in the mud cleaning system by a heat exchange system. Mud cleaning is usually performed simultaneously with drilling operations, so heat generated by the engines while producing energy for drilling operations may be transferred to the mud cleaning system.

The heat exchange system may include a liquid/liquid heat exchanger that transfers heat from the cooling fluid in a cooling system of the engine to the drilling mud. In one exemplary embodiment, the liquid/liquid heat exchanger may be a shell and tube heat exchanger. Drilling mud may flow through the tube of the heat exchanger and cooling fluid may flow through the shell of the heat exchanger. In some embodiments, the shell and tube heat exchanger may include forty-five tubes of 0.75 inch diameter and 8 feet length. The tubes may be spaced so that centers of adjacent tubes are about 1.5 inches apart. The drilling mud may flow through the bore of the tubes at a rate of about 100 gallons per minute. The cooling fluid may flow through the shell at a flow rate of about 150 gallons per minute. In some embodiments, the cooling fluid may have an initial temperature of about 95° C. The length of the tube and shell heat exchanger may be about 60 inches. The tube array may be vertical, which may prevent barite sagging, which in turn may keep the tubes clean and allow the mud to maintain the correct chemical composition. The rate of flow of the drilling mud in the tubes may also be selected to facilitate cleaning of the tubes and prevent deposition of particulates on the inner surfaces of the tubes. Plug flow may be maintained within the shell and tube heat exchanger to keep liquid layers optimized for heat exchange

In some embodiments, the heat exchange system may include a control system. The control system may use feedback control to ensure that the rig engine, the drilling mud, and the centrifuge are at a desired temperature. The control system may further account for other properties of the mud cleaning system.

In some embodiments, the heat exchange system may include one or more secondary circuits through which fluid flows. Each secondary circuit may include an engine heat exchanger which transfers heat from an engine cooling fluid to the fluid of the secondary circuit and a mud heat exchanger which transfers heat from the fluid of the secondary circuit to the mud. The fluid flowing through the secondary circuit may be water. One or both of the engine heat exchanger and the mud heat exchanger may be a shell and tube heat exchanger as described above. The secondary circuit may have an overall length of up to 300 feet, so rockwool may be used to thermally isolate the secondary circuit and prevent heat loss during transport of the fluid of the secondary circuit. In some embodiments, three to six inches of rockwool may be used to surround the secondary circuit.

A heat exchange system that includes a secondary circuit may also include a multi-process control system. An engine temperature control process may maintain the temperature of the engine within a desired range. A cooling fluid control process may maintain the temperature of the cooling fluid that cools the engine within a desired range. An engine heat exchanger control process may control whether or not heat transfer from the engine cooling fluid to the fluid of the secondary circuit at the engine heat exchanger. A mud temperature control process may maintain the temperature of the mud entering the centrifuge in a desired range. A separator control process may maintain the centrifuge at the desired speed and maintain the rate of flow of mud through the centrifuge. This control system may include further control processes which may make use of further temperature probes to control other components of the heat exchange system. The processes may be controlled by a single programmable logic controller connected to a main computer of a drilling rig.

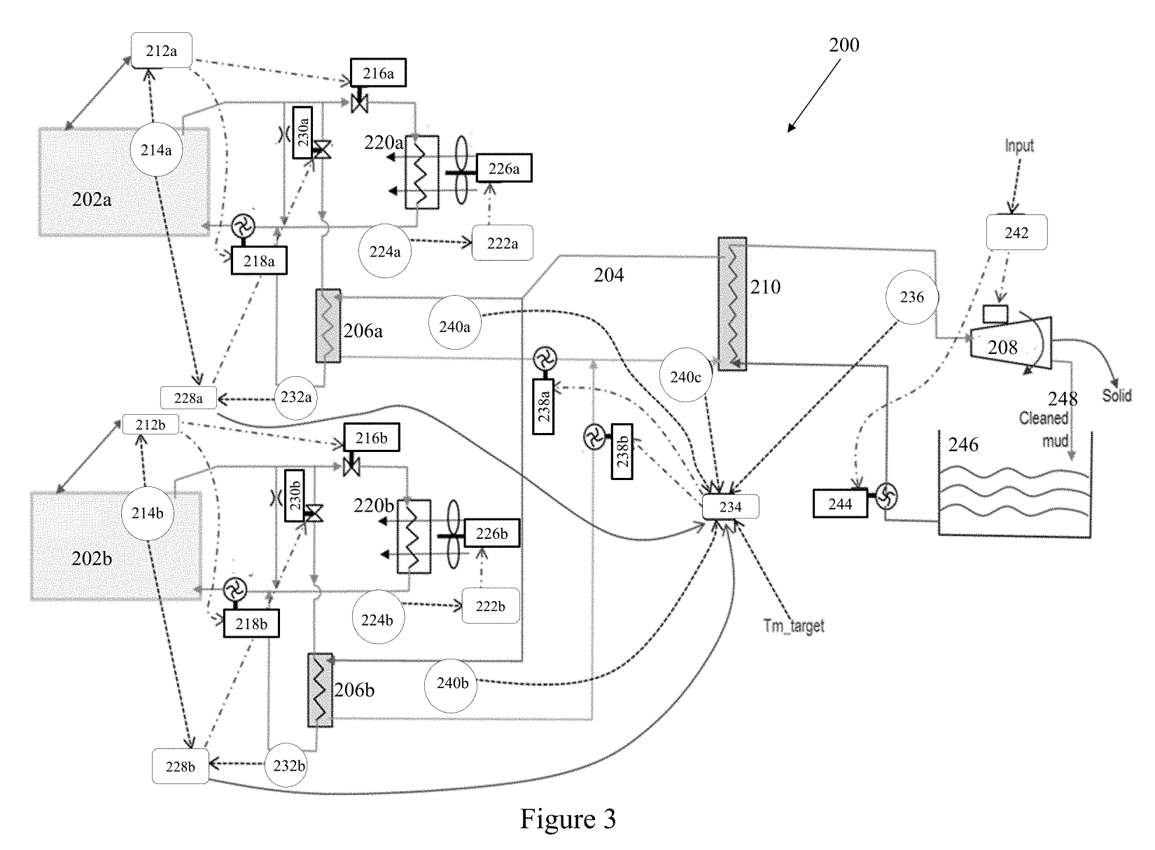

FIG. 3 illustrates a heat exchange system comprising two rig engines, a secondary circuit which includes one mud heat exchanger and two engine heat exchangers, and a multi-part control system. In the embodiment illustrated in FIG. 3, the two engine heat exchangers are liquid/liquid heat exchangers. It will be understood that other variations may be made, such as by changing the number of rig engines, heat exchangers, etc.

As shown, a first rig engine 202a and a second rig engine 202b power a drilling rig (not shown). The excess heat produced by the rig engines 202a, 202b is transferred to the drilling mud in a mud cleaning system (not shown) before the mud enters a centrifuge 208 by the heat exchange system 200. However, it is also envisioned that the excess heat could be transferred to the drilling mud prior to the drilling mud encountering other separators instead of or in addition to the centrifuge 208. Cooling fluid that flows through the first rig engine 202a and the second rig engine 202b transfers heat to the fluid of a secondary circuit 204 in a first engine heat exchanger 206a and a second engine heat exchanger 206b. Before entering the engine heat exchangers 206a, 206b, the cooling fluid may have a relatively “hot” temperature, having already passed through rig engines 202a and 202b. Heat may be transferred away from the cooling fluid in the engine heat exchangers 206a, 206b. Therefore, the cooling fluid may have a relatively “cold” temperature after passing through the engine heat exchangers 206a, 206b because such energy/heat transfers to the secondary circuit 204. A mud heat exchanger 210 transfers heat from the fluid of the secondary circuit 204 to the mud flowing into the centrifuge 208. The centrifuge 208 outputs mud into a holding vessel 246 through a system outlet 248. Heat may be transferred to the fluid of the secondary circuit 204 in the engine heat exchangers 206a, 206b. Heat may be transferred away from the fluid of the secondary circuit 204 in the mud heat exchanger 210. Therefore, fluid of the secondary circuit 204 may have a relatively “hot” temperature after passing through the engine heat exchangers 206a, 206b, and a relatively “cold” temperature after passing through the mud heat exchanger 210. Mud may be relatively “dirty” and have a relatively “cold” temperature before passing through the mud heat exchanger 210 and the centrifuge 208. Mud may be relatively “dirty” and have a relatively “hot” temperature after passing through the mud heat exchanger 210. Once heated, the mud may be cleaned by centrifuge 208.

A first engine temperature control process 212a and a second engine temperature control process 212b may use a first engine temperature probe 214a and a second engine temperature probe 214b to measure a temperature of the first rig engine 202a and the second rig engine 202b, respectively. The engine temperature control processes 212a, 212b may control the speed of engine pumps 218a, 218b to control the flow of cooling fluid through the first rig engine 202a and the second rig engine 202b, respectively. The engine temperature control processes 212a, 212b may control engine valves 216a, 216b that allow cooling fluid to pass through radiators 220a, 220b for additional cooling based on the measured temperature of the first rig engine 202a and the second rig engine 202b, respectively. In some embodiments, the rig engines 202a, 202b may be maintained in the range 85° C.-125° C. A first cooling fluid control process 222a and a second cooling fluid control process 222b may maintain the temperature of the cooling fluid that cools the first rig engine 202a and the second rig engine 202b, respectively, within a desired range. The cooling fluid control processes 222a, 222b may use a first cooling fluid temperature probe 224a and a second cooling fluid temperature probe 224b to measure a temperature of the cooling fluid before the cooling fluid enters the first rig engine 202a and the second rig engine 202b, respectively. If the cooling fluid is too hot, the cooling fluid control processes 222a, 222b may activate a first fan 226a or a second fan 226b proximate the first radiator 220a or the second radiator 220b, respectively, to force convection through the radiator and to increase the cooling effect.

A first engine heat exchanger control process 228a and a second engine heat exchanger control process 228b may control whether or not heat transfers from the engine cooling fluid to the fluid of the secondary circuit at the first engine heat exchanger 206a and the second heat exchanger 206b, respectively. The engine heat exchanger control processes 228a, 228b may control whether or not heat transfer occurs by controlling a first engine heat exchanger valve 230a and a second engine heat exchanger valve 230b that allows engine cooling fluid to enter the first engine heat exchanger 206a and the second heat exchanger 206b, respectively. The engine heat exchanger control processes 228a, 228b may use the engine temperature probes 214a, 214b to measure a temperature of the rig engines 202a, 202b and use a first engine heat exchanger temperature probe 232a and a second engine heat exchanger temperature probe 232b to measure a temperature of the engine cooling fluid exiting the first engine heat exchanger 206a and the second heat exchanger 206b, respectively. If the temperature of the rig engine 202a, 202b is higher than a critical temperature, the engine heat exchanger control process 228a, 228b may close the engine heat exchanger valve 230a, 230b to prevent engine cooling fluid from entering the first engine heat exchanger 206a and the second heat exchanger 206b, respectively. If the temperature of the cooling fluid is higher than the temperature of the rig engine 202a, 202b, the engine heat exchanger control process 228a, 228b may close the engine heat exchanger valve 230a, 230b to prevent engine cooling fluid from entering the first engine heat exchanger 206a and the second heat exchanger 206b, respectively. If the temperature of the cooling fluid is lower than a threshold temperature, the engine heat exchanger control process 228a, 228b may close the engine heat exchanger valve 230a, 230b to prevent the cooling fluid from cooling the first rig engine 202a or the second rig engine 202b, respectively, to a too low temperature. A mud temperature control process 234 may maintain the temperature of the mud entering the centrifuge 208 in a desired range. The mud temperature control process 234 may use a mud temperature probe 236 to measure a temperature of the mud entering the centrifuge 208. If the temperature of the mud is too low, the mud temperature control process 234 may activate a first secondary circuit pump 238a or a second secondary circuit pump 238b to increase the flow of heated fluid in the secondary circuit 204 through the mud heat exchanger 210. The mud temperature control process 234 may also measure a temperature of the fluid in the secondary circuit using three secondary circuit fluid probes 240a, 240b, 240c. In one or more embodiments, the temperature within the secondary circuit (at the hottest point) may be limited to 145 or 140 deg. C. (so as to avoid hazardous temperatures to meet safety requirements for operating in zones with gases); however, it is understood that such temperature may also depend, for example, of the operating pressure of the system. The mud temperature control process 234 may communicate with the engine heat exchanger control processes 228a, 228b so that if a rig engines 202a, 202b are not in a condition to allow cooling fluid to flow through an engine heat exchanger 206a, 206b, the mud temperature control process 234 may prevent the flow of fluid through the secondary circuit 204. The desired temperature range of oil based drilling mud may be related to the flash-point of the oil based mud (i.e., 85 deg C.). The upper limit of the desired temperature range for water based mud may be related to the ebullition of the water based mud and the evaporation of water from the water based mud (i.e., 100 deg C.). In this and the other described embodiments, the mud may be heated, for example to at least 60 deg C., at least 70 deg C. or at least 75 deg C. In some instances, such as where water-based fluids are used, higher temperatures up to 90 deg C. may be used.

A separator control process 242 may maintain the centrifuge 208 at the desired speed. The separator control process 242 may also maintain the rate of flow of mud through the centrifuge 208 by controlling the speed of a centrifuge pump 244 that pumps mud into the mud heat exchanger 210 and then into the centrifuge 208. The desired values for the speed of the centrifuge and the rate of flow of the mud may be set by user input. Further, while each of the control processes described above are presented as independent, it is envisioned that they may be combined and operated even from a single programmable logic controller (PLC). In some embodiments, the PLC is also connected to a main computer of a rig that manages the planning of the drilling activity. Thus, the planning of the mud cleaning process may be performed. For example, the available heat may be planned so that the centrifuge and cleaning operation can be predicted and the overall cleaning process optimized, including planning for chemical addition to the mud for mud recycling and preparation.

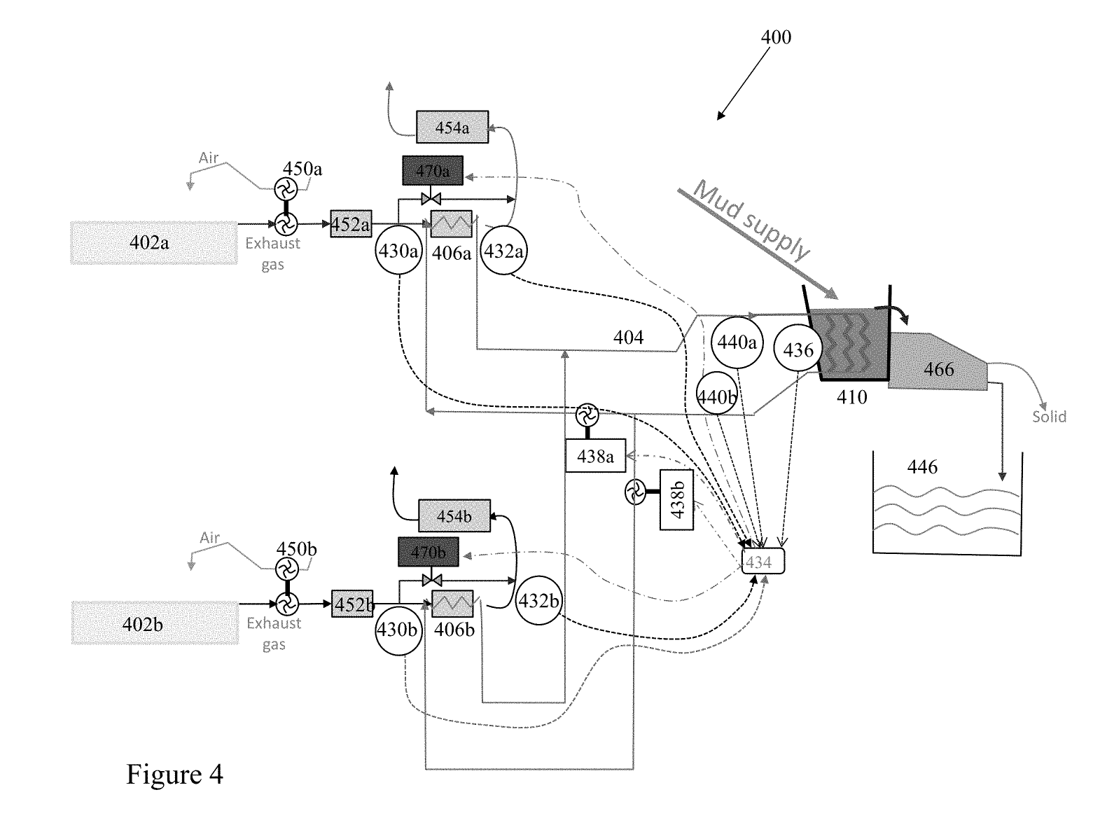

FIG. 4 illustrates a heat exchange system comprising two rig engines, a secondary circuit which includes one mud heat exchanger and two engine heat exchangers, and a multi-part control system. This embodiment may be directed towards the recovery of the residual heat in the exhaust gas of the engines. In the embodiment illustrated in FIG. 4, the two engine heat exchangers are gas/liquid heat exchangers. It will be understood that other variations may be made, such as by changing the number of rig engines, heat exchangers, etc.

As shown, a first rig engine 402a and a second rig engine 402b power a drilling rig (not shown). The excess heat produced by the rig engines 402a, 402b is transferred to the drilling mud before the mud enters a shale shaker 466 by the heat exchange system 400. Each engine may provide, for example, up to 1 MWatt of heat from its exhaust that may be transferred to the mud. There may be about 500 gallons per minute (GPM) of mud flowing out of the well, and thus, assuming there are three engines (with a total of 3 MWatts of heat), the overall mud temperature could be raised by 20 to 25 deg C. (such as when processing the whole mud flow at the shaker). However, it is also envisioned that the excess heat could be transferred to the drilling mud prior to the drilling mud encountering other separators instead of or in addition to the shale shaker 466. When heating subsequent separators after the shaker, the mud flow is lower than the when it was circulating out of the well and into the shakers. Thus, it is understood that for a given number of engines, the mud temperature increase may be greater when there is lower flow at subsequent separators, such as to about 75 deg C. For a flow of about 50 to 100 GPM, a temperature of about 75 deg C. may be achieved with only about 1 MWatt of heat. In such an instance, the heated mud flowing out of one of the downstream separators (such as at a rate of 50-100 GPM), such as a centrifuge, may mix with cold mud in the mud tank system (flowing at a rate of 500 to 600 GPM), thereby having an effect only raising the temperature of the mixed mud by only about 10 deg C. over the general cold mud flow.

Turning to the embodiment illustrated in FIG. 4, the engine turbo-compressors 450a, 450b, driven by the exhaust gas, may inject air into the rig engines 402a, 402b. After passing through the turbo-compressor 450a and 450b, the exhaust gas into catalyst convertors 452a, 452b. Them the exhaust gas may flow into a first engine heat exchanger 406a and a second engine heat exchanger 406b and transfer heat to the fluid of a secondary circuit 404. Exhaust gas may exit the engine heat exchangers 406a, 406b through mufflers 454a, 454b. A mud heat exchanger 410 may transfer heat from the fluid of the secondary circuit 404 to the mud flowing into the shale shaker 466. Specifically, secondary circuit 404 includes hot water that flows from engine heat exchangers 406a, 406b to mud heat exchanger 410 through which mud passes (thus heating mud) prior to entering shale shaker 466. The shale shaker 466 may output mud into a holding vessel 446. In one or more embodiments, the mud heat exchanger 410 may be integrated or built within the header tank of the shale shaker 466. For example, the secondary circuit 404 fluid may flow through a network of pipes that are submerged in the header tank, thereby heating the mud prior to it entering the shale shaker 466. Secondary circuit also includes cold water that flows out of mud heat exchanger 410 back to engine heat exchangers 406a, 406b. Further, it is also envisioned that secondary circuit (in this or any of the described embodiments) may include a fluid other than or in addition to water. For example, in or more embodiments, a water and glycol mixture may be used.

A temperature-based control system 434 may maintain the temperature of fluid in the secondary circuit 404 within a desired range. The control system 434 may thereby maintain the temperature of the mud which enters the shale shaker 466 within a desired range. The control system 434 may include one or more of the following temperature probes: engine heat exchanger temperature probes 430a, 430b, which measure the temperature of exhaust gas entering the engine heat exchangers; exhaust gas temperature probes 432a, 432b, which measure the temperature of the exhaust gas exiting the engine heat exchangers; secondary circuit temperature probes 440a, 440b, which measure the temperature of the fluid in the secondary circuit; and mud temperature probe 436 which measures the temperature of the mud in the mud heat exchanger 410.

The control system 434 may maintain the temperature of the mud in the heat exchanger 410 below a specified critical level of the mud. This critical level may be a flash-point for oil based mud or an ebullition point for water based mud. The control system 434 may maintain the temperature of the fluid in the secondary circuit 404 below a hazardous zone for the shale shaker 466, the mud cleaning system (not shown), and/or a drilling system (not shown). The flow of fluid through the secondary circuit 404 may be controlled by pumps 438a, 438b controlled by the control system 434 to maintain the temperature of the fluid in the secondary circuit 404 within the desired range. The flow of exhaust gas into the engine heat exchangers 406a, 406b may be controlled by by-pass valves 470a, 470b controlled by the control system 434 to maintain the temperature of the fluid in the secondary circuit 404 within the desired range. For example, the by-pass valves 470a, 470b may prevent the flow of exhaust gas into one or more of the engine heat exchangers 406a, 406b if the temperature of the fluid in the secondary circuit 404 becomes too high.

Heat may be transferred to the fluid of the secondary circuit 404 in the engine heat exchangers 406a, 406b. Heat may be transferred away from the fluid of the secondary circuit 404 in the mud heat exchanger 410. Therefore, fluid of the secondary circuit 404 may have a relatively “hot” temperature after passing through the engine heat exchangers 406a, 406b, and a relatively “cold” temperature after passing through the mud heat exchanger 410. Mud may be relatively “dirty” and have a relatively “cold” temperature before passing through the mud heat exchanger 410 and the centrifuge 408. Mud may be relatively “clean” and have a relatively “hot” temperature after passing through the mud heat exchanger 410 and the centrifuge 408.

Thus, as shown in FIG. 4, in some embodiments of the mud cleaning system, the heat transfer system may include an engine heat exchanger which may be a gas/liquid heat exchanger and may transfer heat from the exhaust gas of the engine to the fluid of a secondary circuit. The mud heat exchanger may be a liquid/liquid heat exchanger, as described above in FIG. 3, and may be used to transfer heat from the fluid of the secondary circuit to the drilling mud. The fluid used in the secondary circuit may perform the heat transfers at a higher temperature to reduce the diameter of the piping needed for the secondary circuit. The temperature of the fluid in the secondary circuit may be about 140° C. The temperature of the fluid in the secondary circuit at the mud heat exchanger may be limited by safety requirements for hazardous zones. Water or a water based fluid may be used as the fluid in the secondary circuit and the temperature of the fluid in the secondary circuit may depend on the pressure experienced by the fluid. A heat exchange system including an engine heat exchanger which is a gas/liquid heat exchanger may further include a multi-process control system similar to that described.

In some embodiments, a mud cleaning system may maintain oil based drilling mud below the flash-point temperature of the oil based mud and maintain water based drilling mud below the ebullition temperature of the water based mud. Maintenance of the drilling mud below the flash-point temperature or the ebullition temperature may be achieved by an active controller.

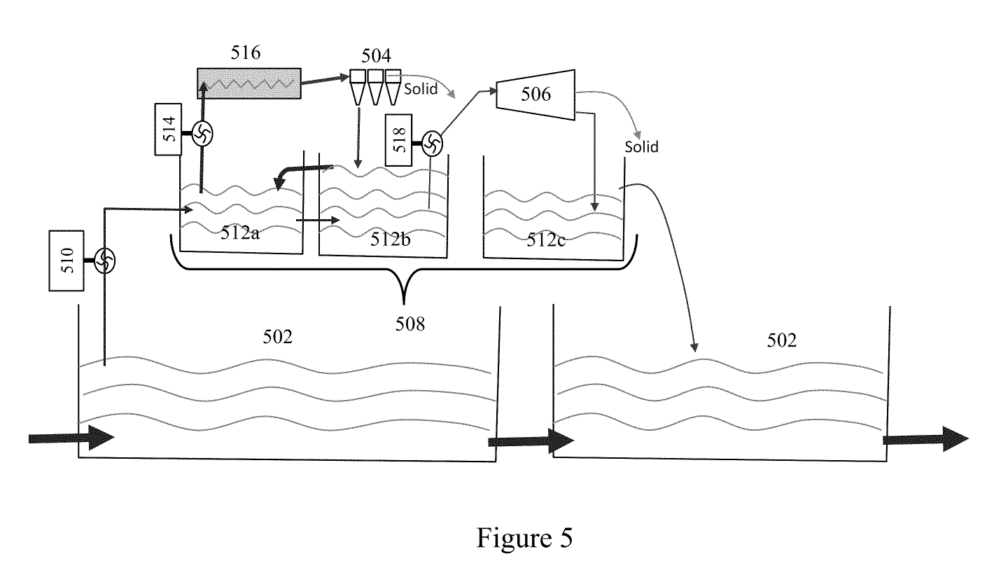

FIG. 5 illustrates an embodiment of a mud cleaning system which includes parallel mud flow. The flow of mud occurs through a primary flow pathway 502. The primary flow pathway 502 may include one or more tanks, one or more passageways between the tanks, and one or more pumps. The flow rate of mud through the primary flow pathway 502 may not be controlled. The flow rate of mud through the primary flow pathway 502 may be high.

In some embodiments, only a portion of the mud flowing through the primary flow pathway 502 may be processed by hydro-cyclones 504 and a centrifuge 506. The hydro-cyclones may include one or more desanders and one or more desilters. The portion of the mud which is processed by the hydro-cyclones 504 and the centrifuge 506 may flow through a secondary flow pathway 508. A pump 510 may pump mud from the primary flow pathway 502 into the secondary flow pathway 508.

The secondary flow pathway 508 may include three or more tanks 512a, 512b, and 512c. A pump 514 may pump mud from the first tank 512a into a heat exchanger 516. In some embodiments, the heat exchanger 516 may use engine cooling fluid or exhaust gas directly to heat the mud. In some embodiments, the heat exchanger 516 may use a fluid in a secondary circuit, as discussed with respect to FIGS. 3 and 4, to heat the mud. Mud may flow from the heat exchanger 516 into the hydro-cyclones 504. Heated mud may flow from the hydro-cyclones 504 into the second tank 512b. Solids may be discarded from the hydro-cyclones 504. Mud may also flow directly between the first tank 512a and the second tank 512b. Mud may flow from the first tank 512a to the second tank 512b through a passageway. Mud may flow from the second tank 512b to the first tank 512a when mud overflows the second tank 512b. The flow rate across the hydrocyclones 504 and centrifuge 506 may not be equal, and thus second tank 512b may serve as a buffer tank and also allow for recirculation of the mud through hydrocylone 504.

A pump 518 may pump mud from the second tank 512b into the centrifuge 506. Mud may flow from the centrifuge 506 into the third tank 512c. Solids may be discarded from the centrifuge 506. Mud may flow from the third tank 512c into the primary flow pathway 502.

The mud in the primary flow pathway 502 may have a relatively “cold” temperature. Mud entering the secondary flow pathway 508 may remain at a relatively “cold” temperature as the mud in the primary flow pathway 502. The heat exchanger 516 may transfer heat to the mud. Therefore, after flowing through the heat exchanger, the mud may have a relatively “hot” temperature. The mud may remain at a relatively “hot” temperature while it is in the secondary flow pathway 508. After mud at a relatively “hot” temperature flows back into the primary flow pathway 502, the mud may mix with mud at a relatively “cold” temperature. The flow volume of the mud at a relatively “cold” temperature in the primary flow pathway 502 may be substantially larger (such as a more than 4-fold difference) than the flow volume of the mud at a relatively “hot” temperature coming from the secondary flow pathway 508. Therefore, mud in the primary flow pathway 502 may remain at a relatively “cold” temperature.

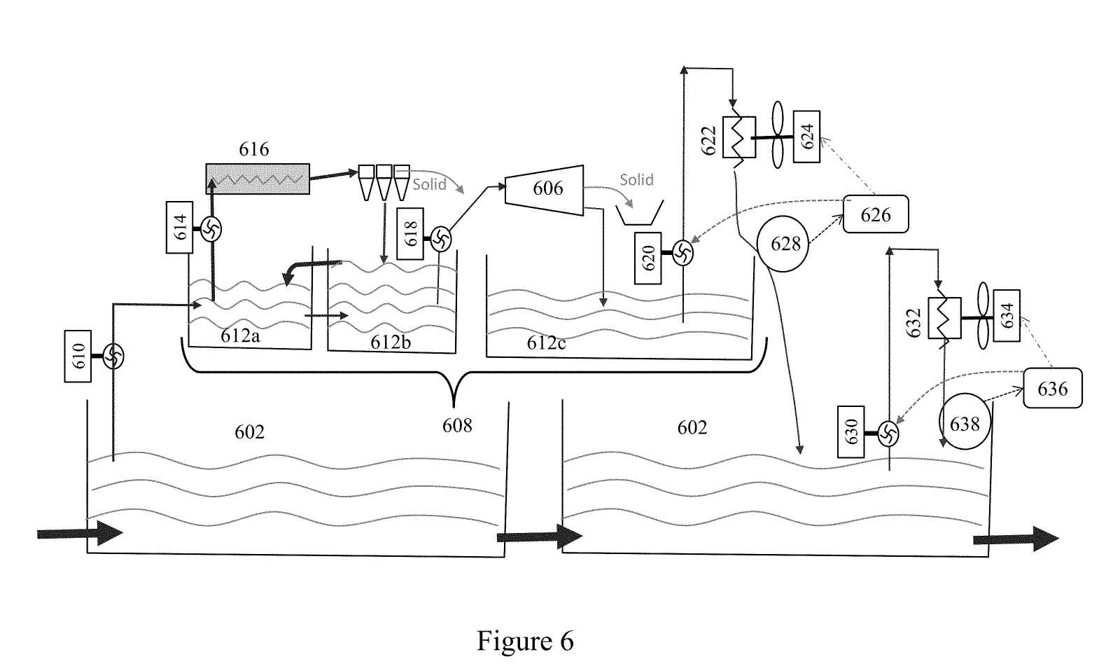

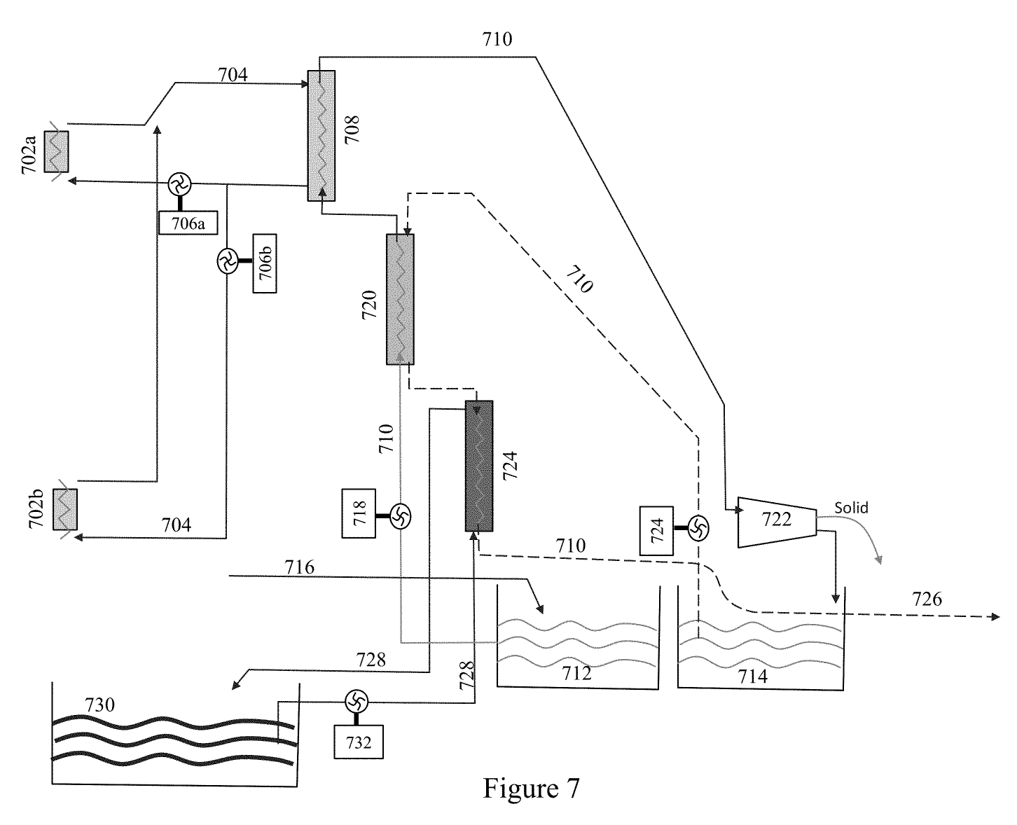

The mud cleaned by a mud cleaning system may be cooled before it is stored in a holding vessel or pit. Cooling the mud may allow the mud exiting the mud cleaning system to have a temperature similar to the mud entering the heat transfer system. Mud which has been heated may be diluted with mud which has not been heated, as shown in FIG. 5. The final mixture of mud may have a temperature within 10 degrees Celsius or within 20 degrees Celsius of the temperature of the mud before it entered the heat transfer system. Radiators with fans may be used to cool the mud, as shown in FIG. 6. The temperature of the mud which exits the mud cleaning system may be within 8 degrees Celsius or within 16 degrees Celsius of the temperature of the mud before it entered the heat transfer system. In some embodiments, the mud cleaning system may use a cross-flow of heat to cool the mud, as shown in FIG. 7. The cross-flow of heat may be facilitated by a mud/liquid heat exchanger, using cold water from a horse shoe pit associated with the mud cleaning system. The temperature of the mud which exits the mud cleaning system may be within 3 degrees Celsius or within 7 degrees Celsius of the temperature of the mud before it entered the heat transfer system. These cooling methods may improve mud performance in wellbore operations because it may be desirable for the mud used in wellbore operations to be close to the ambient temperature, which may be significantly cooler than the temperature to which mud may be heated using a heat transfer system.

FIG. 6 illustrates an embodiment of a mud cleaning system which includes a radiator with a fan to cool the mud exiting the system. The flow of mud occurs through a primary flow pathway 602. The primary flow pathway 602 may include one or more tanks, one or more passageways between the tanks, and one or more pumps. The flow rate of mud through the primary flow pathway 602 may not be controlled. The flow rate of mud through the primary flow pathway 602 may be high.

In some embodiments, only a portion of the mud flowing through the primary flow pathway 602 may be processed by hydro-cyclones 604 and a centrifuge 606. The hydro-cyclones may include one or more desanders and one or more desilters. The portion of the mud which is processed by the hydro-cyclones 604 and the centrifuge 606 may flow through a secondary flow pathway 608. A pump 610 may pump mud from the primary flow pathway 602 into the secondary flow pathway 608.

The secondary flow pathway 608 may include three or more tanks 612a, 612b, and 612c. A pump 614 may pump mud from the first tank 612a into a heat exchanger 616. In some embodiments, the heat exchanger 616 may use engine cooling fluid or exhaust gas directly to heat the mud. In some embodiments, the heat exchanger 616 may use a fluid in a secondary circuit, as discussed with respect to FIGS. 3 and 4, to heat the mud. Mud may flow from the heat exchanger 616 into the hydro-cyclones 604. Mud may flow from the hydro-cyclones 604 into the second tank 612b. Solids may be discarded from the hydro-cyclones 604. Mud may also flow directly between the first tank 612a and the second tank 612b. Mud may flow from the first tank 612a to the second tank 612b through a passageway. Mud may flow from the second tank 612b to the first tank 612a when mud overflows the second tank 612b. Thus, second tank 612b may serve as a buffer tank and optional recirculation for mud prior to entering centrifuge 606, as described above.

A pump 618 may pump mud from the second tank 612b into the centrifuge 606. Mud may flow from the centrifuge 606 into the third tank 612c. Solids may be discarded from the centrifuge 606. A pump 620 may pump mud from the third tank 612c into a radiator 622 cooled by a fan 624. Mud may flow from the radiator 622 into the primary flow pathway 602. A control system 626 may control whether or not the fan 624 is turned on while mud flows through the radiator 622. The control system 626 may include a temperature probe 628 which measures the temperature of mud flowing from the radiator 622 into the primary flow pathway 602. If the measured temperature is above a threshold, the fan 624 may be turned on. If the measured temperature is below a threshold, the fan 624 may be turned off. The control system 626 may also control the rate at which the pump 620 pumps mud out of the third tank 612c. Thus, control system 626 may drive the pump 620 and fan 624 to achieve an optimum cooling effect.

A pump 630 may pump mud from the primary flow pathway 602 into a radiator 632 cooled by a fan 634. Mud may flow from the radiator 632 back into the primary flow pathway 602. A control system 636 may control whether or not the fan 634 is turned on while mud flows through the radiator 632. The control system 636 may include a temperature probe 638 which measures the temperature of mud flowing from the radiator 632 into the primary flow pathway 602. If the measured temperature is above a threshold, the fan 634 may be turned on. If the measured temperature is below a threshold, the fan 634 may be turned off. The control system 636 may also control the rate at which the pump 630 pumps mud out of the primary flow pathway 602.

The mud in the primary flow pathway 602 may have a relatively “cold” temperature. Mud entering the secondary flow pathway 608 may remain at a relatively “cold” temperature as the mud in the primary flow pathway 602. The heat exchanger 616 may transfer heat to the mud. Therefore, after flowing through the heat exchanger, the mud may have a relatively “hot” temperature. The mud may remain at a relatively “hot” temperature while it is in the secondary flow pathway 608. The radiator 622 may cool the mud to a relatively “warm” temperature as it exits the secondary flow pathway 608 and reenters the primary flow pathway 602. After mud at a relatively “warm” temperature reenters the primary flow pathway 602. As mud at a relatively “warm” temperature flows back into the primary flow pathway 602, the mud may mix with mud at a relatively “cold” temperature. The flow volume of the mud at a relatively “cold” temperature may be larger than the flow volume of the mud at a relatively “warm” temperature. Therefore, mud in the primary flow pathway 602 may remain at a relatively “cold” temperature. The radiator 634 may transfer heat away from mud, such that mud which exits the radiator may be at a relatively “colder” temperature. As mud at a relatively “colder” temperature flows back into the primary flow pathway 602, the mud may mix with mud at a relatively “cold” temperature. The flow volume of the mud at a relatively “cold” temperature may be larger than the flow volume of the mud at a relatively “colder” temperature. Therefore, mud in the primary flow pathway 602 may remain at a relatively “cold” temperature.

In an exemplary embodiment, mud entering the primary flow pathway 602 may be about twenty degrees Celsius. The heat exchanger 616 may heat the mud to about seventy degrees Celsius. All mud in the secondary flow pathway 608 may have a temperature of about seventy degrees Celsius. The radiator 622 may cool the mud exiting the secondary flow pathway 608 to about fifty-five degrees Celsius. The mud exiting the secondary flow pathway 608 mixes with the mud in the primary flow pathway 602. The mud in the primary flow pathway 602 may be further cooled by the radiator 632 to a temperature of about twenty-eight degrees Celsius. Further, it may be understood that these temperatures are just examples and that other temperature levels may be obtained depending on the peak temperature desired for the separation, as well as the cooled temperature desired for recirculation of the mud downhole. With the radiator cooling the secondary flow, an amount of heat (such as 200 kWatt) may be extracted from the mud, with a temperature reduction of about 20% of the temperature increase, prior to the final dilution. Further, the radiator in the primary flow may also have a cooling effect, though the temperature delta would be lower given the lower mud temperature.

FIG. 7 illustrates an embodiment of a mud cleaning system which uses a cross-flow of heat to cool the mud. The cross-flow of heat is facilitated by a mud cooling heat exchanger. Two engine heat exchangers 702a, 702b transfer heat from two rig engines (not shown) to a secondary circuit 704. The engine heat exchangers 702a, 702b may be connected to the rig engines using circuits such as those shown in FIGS. 3 and 4. The engine heat exchangers 702a, 702b may be connected to the rig engines using any means known in the art. Two pumps 706a, 706b may pump a fluid through the secondary circuit 704. A mud heat exchanger 708 may transfer heat from the secondary circuit 704 to a mud centrifuge circuit 710. The engine heat exchangers 702a, 702b may heat the fluid in the secondary circuit 704 to an elevated temperature, such that the fluid that flows out of the engine heat exchangers 702a, 702b is “hot.” The mud heat exchanger 708 may cool the fluid in the secondary circuit 704, such that the fluid that flows out of the mud heat exchanger 708 is “cold.” The fluid in the secondary circuit may be water.

The mud centrifuge circuit 710 may include a first tank 712 and a second tank 714. Mud may flow through an inlet 716 into the first tank 712. The mud which flows into the first tank 712 may be uncleaned or partially cleaned. A pump 718 may pump mud from the first tank 712 into a first passageway of a mud/mud heat exchanger 720, to heat the mud to a first elevated temperature (i.e., the mud exiting the mud/mud heat exchanger 720 may be referred to as a “warm” mud). The warm mud may flow from the mud/mud heat exchanger 720 into the mud heat exchanger 708, which, via the hot fluid of the secondary circuit 704, further heats the warm mud to a second elevated temperature (greater than the first elevated temperature, such that the mud is “hot”). The hot mud may flow from the mud heat exchanger 708 into a centrifuge 722. The hot mud may flow from the centrifuge 722 into the second tank 714. Solids may be discarded from the centrifuge 722. A pump 724 may pump hot clean mud from the second tank 714 into a second passageway of the mud/mud heat exchanger 720 (which provides the heat to create the “warm” mud referred to above), thereby cooling the hot clean mud (such as again to a “warm” state). Warm clean mud may flow from the second passageway of the mud/mud heat exchanger 720 into a mud cooling heat exchanger 724, to further cool the warm, clean mud to a cold, clean mud. Cold, clean mud may flow from the mud cooling heat exchanger 724 to an outlet 726.

The mud/mud heat exchanger 720 may facilitate the transfer of heat from warmer clean mud which has just exited the second tank 714 to cooler dirty mud which has just exited the first tank 712. Thus, heat may be transferred from mud which is closer to the system outlet 726 to mud which is farther from the system outlet 726 (and not yet cleaned by centrifuge 722 (or another separator).

The mud cooling heat exchanger 724 may transfer heat from the mud centrifuge circuit 710 to a mud cooling circuit 728. In the mud cooling circuit 728, a pump 732 may pump water from a cold water pit 730 into the mud cooling heat exchanger 724. Water may flow from the mud cooling heat exchanger 724 back into the cold water pit 730. The cold water pit 730 may be any means known in the art for holding a relatively large amount of relatively cold water or other fluid. In some embodiments, a fluid other than water may flow through the mud cooling circuit 728. Further, it is also envisioned that the use of cold water from the pit to cool the mud may be used in combination with the radiators used in FIGS. 5 and 6, though the combination of the two may not have a linear effect of cooling.

In an exemplary embodiment, dirty mud flowing into the first tank 712 may be twenty degrees Celsius. Dirty mud flowing through the first passageway of the mud/mud heat exchanger 720 may be heated to about thirty-five degrees Celsius. The mud heat exchanger 708 may heat dirty mud to about seventy degrees Celsius. The mud may remain at about seventy degrees Celsius, while being cleaned by centrifuge 722 (and becoming clean mud) until it reaches the second passageway of the mud/mud heat exchanger 720. Clean mud flowing through the second passageway of the mud/mud heat exchanger may be cooled to about fifty-five degrees Celsius. Clean mud flowing through the mud cooling heat exchanger may be cooled to about forty degrees Celsius. Clean mud may exit the outlet at about forty degrees Celsius. Water in the cold water pit 730 may be about twenty degrees Celsius. Water which flows through the mud cooling heat exchanger may be heated to about twenty-five degrees Celsius. The size of the cold water pit 730 may help maintain the temperature of the cold water pit 730 at about twenty degrees Celsius. Further, it may be understood that these temperatures are just examples and that other temperature levels may be obtained depending on the peak temperature desired for the separation, as well as the cooled temperature desired for recirculation of the mud downhole.

A heat exchange system which transfers heat from a rig engine to drilling mud may reduce waste on the drilling rig by reducing the amount of power produced by the engine which goes unused and may also prevent an additional heat source from having to be added to the drilling rig. Transferring heat from a rig engine to drilling mud also reduces thermal pollution.

A heater, including those described above, may also be used to heat the drilling mud before the drilling mud enters any separator in the mud cleaning system. The separator may be a shale shaker, a desander, or a desilter, for example. Heating drilling mud before the drilling mud enters any separator may present similar advantages to heating the drilling mud before it enters a centrifuge. In some embodiments of the mud cleaning system, multiple heaters may be used to heat the mud entering multiple separators. In some embodiments of the mud cleaning system, the drilling mud may maintain the heat from a single heater as it flows through multiple separators.

Heating drilling mud may provide several advantages. As discussed above, more particulates may be removed from drilling mud that is heated during cleaning. Some of these particulates may be low gravity solids. Reduction of low gravity solid levels in drilling mud may increase the rate of penetration of the drill bit and decrease the erosion of downhole tools, which in turn reduces non-productive time and increases drilling efficiency. Drilling mud at a higher temperature may have a higher Nusselt number and thus a higher heat transfer coefficient. Drilling mud at higher temperatures also has a higher value of the absolute value of the zeta potential. Thus, the repulsion between the charged particles is increased, which prevents agglomeration of charged particles and other particulates and prevents sedimentation in the wellbore.

After being heated and passing through a separator, the drilling mud may be cooled to a desired lower the temperature to ensure proper behavior during recirculation inside the wellbore. The behavior of pumps and seals may depend on the drilling mud being at the desired temperature. Some methods of cooling are described above. However, it is also envisioned that the mud may be cooled by other methods as well (whether alone or in combination with the above described methods). For example, in some embodiments of the mud heating system, the holding vessel to which mud is discharged from the separator may be a mud tank. The mud tank may cool the mud through convection at the side walls of the mud tank and by evaporation at the surface of the tank. Heat transfer by convection at the side wall of a tank may involve several processes. First is heat transfer from the mud to the steel wall, involving both conduction and convection. This heat transfer is efficient as the liquid has good density and specific heat, as well as good heat conductivity. Fluid agitation and movement inside the tank may also improve internal heat transfer by convection (from natural to forced convection). Second is heat transfer by conduction through the metallic wall (most metals have high heat conduction). Third is heat transfer by convection between the walls to the external air. This is the main barrier for heat transfer as the air has a low thermal capacity, low thermal conduction and often low velocity. It is also understood that evaporation may occur at the surface of the mud. Thus, for mud at 70 deg C. in a standard mud tank, approximately 5 kW of heat may be lost each by evaporation and natural convection.

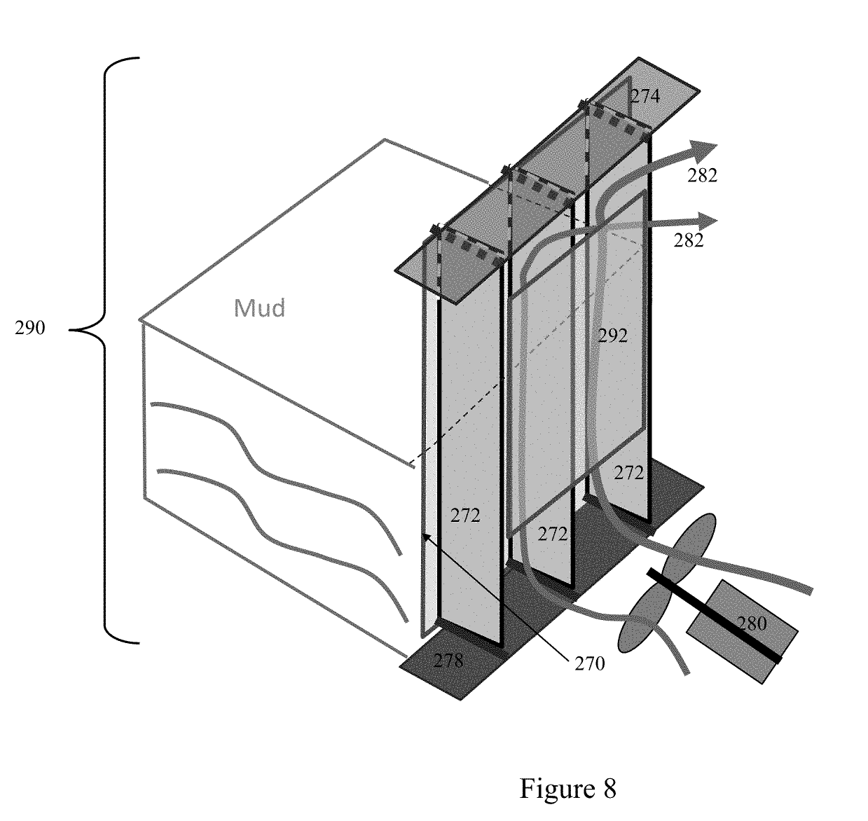

Thus, in some embodiments, the mud tank may be designed to increase the heat transfer experienced by the drilling mud. As shown in FIG. 8, the mud tank 290 may have vertical fins 272 protruding from the side walls 270 on an exterior side to increase the surface area of the tank which is in contact with outside air, thereby increasing the convective heat transfer from the mud to the tank (cooling the mud prior to recirculation downhole). In some embodiments, the fins 272 may be integrally formed with the side walls 270 or may be welded thereof. In another embodiment, the fins 272 are not actually attached to the side walls 270 but are instead only in contact with, but not welded or otherwise attached directly to the side walls 270. For example, in some embodiments, the mud tank may include horizontal rails disposed at the top 274 and bottom 278 of the mud tank and rectangular fins may be disposed between the rails 274, 278. The fins 272 may welded to the top rail 274 and the bottom rail 278. The edge of the fin in contact with the tank may be flat. The wall of the mud tank may be thin enough to be pushed against the edge of the fin by the pressure created by the drilling mud inside the tank. The thickness and the width of the rectangular fins may be chosen for optimum conduction through the metal of the fin so that the convection at the external surface of the fin allows optimum heat transfer. In such embodiment, the fins 272 can be a different metal than the side wall 270, selected, for example, to have better conduction within the fins (i.e., a metal such as aluminum). The design of fins 272 may also be selected to optimize heat transfer. For example, the fin thickness may be adapted to the fin's lateral extend because conduction through the fin material may create a temperature gradient therethrough: at the tip, less heat transfer is achieved because the fin body may be colder. The use of high conductivity material may reduce the temperature gradient through the fin and thus allows the use of longer fins.

Convection may also be optimized through selection of the number of fins disposed along a wall of the mud tank to ensure desired spacing therebetween so that gas may move adequately between the fins to provide for proper convection effect with adequate removal of heat from the fin surface. Rectangular fins disposed between rails at the top and bottom of the mud tank may be easily reconfigured to optimize convection for different compositions of drilling mud and may be easily replaced. The fins may at least double the heat flux by natural convection. Forced convection may allow for a substantially greater heat flux. Thus, in some embodiments, a fan 280 may force air flow 282 along the wall of the tank between the fins 272 to provide forced convection. An exterior wall 292 may facilitate air flow through the spaces between the fins 272. In some embodiments, heat transfer by convection at the tank wall may be doubled or tripled. In some embodiments, convection may be increased by four-fold to ten-fold. In some embodiments, heat exchange by forced convection may be boosted to twenty to fifty kilowatts per tank. Further, it is also envisioned that other cooling mechanisms may be incorporated, such as through evaporation. That is, in some embodiments, evaporation from a mud tank may also generate a cooling effect as energy is “given” to the vapor during the phase change from liquid to vapor. Evaporation may be increased by passing the fluid above a baffle plate, which may be configured in way that would increase evaporation, such as a weir plate that divides the mud tank into multiple compartments. However, as mentioned, other cooling mechanisms may be used, such as a pebbled fluid flow path (en route to a mud tank) that induces some turbulent flow and increases air exposure to the fluid, or a cooling tower may be used without departing from the scope of the present disclosure. The mud in the tank may be agitated to further promote heat transfer by convection.

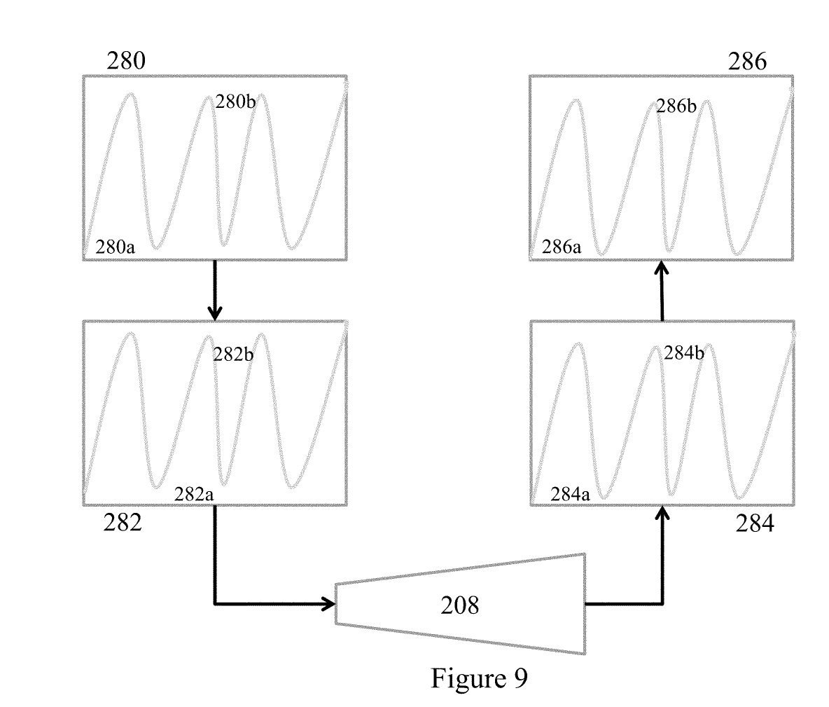

In some embodiments of the mud cleaning system, mud may be heated in stages using multiple heat exchangers before and after a separator. This may result in effective utilization of the released engine heat and better control and efficiency of the heating process. FIG. 9 illustrates a heat exchange system using staged heat exchange and including four shell and tube heat exchangers. In the first shell and tube heat exchanger 280, a heated fluid (such as but not limited to heated water, such as a cooling fluid used to cool rig engines or pumps) may flow through the shell 280a and unheated drilling mud may flow through the tube 280b. In the second shell and heat exchanger 282, heated drilling mud may flow through the shell 282a and unheated drilling mud may flow through the tube 282b. This may allow the heat of the mud exiting the centrifuge 208 to be recovered. Heated drilling mud may then flow through the centrifuge 208 and may exit the centrifuge 208 into the third shell and tube heat exchanger 284. In the third shell and tube heat exchanger 284, heated drilling mud may flow through the tube 284b and unheated fluid (such as pit water) may flow through the shell 284a. In the fourth shell and tube heat exchanger 286, heated drilling mud may flow through the tube 286b and unheated fluid (such as pit water) may flow through the shell 286a. In this way, the drilling mud may be cooled after it exits the centrifuge 208 and heat transferred to the drilling mud before the drilling mud enters the centrifuge may be recovered in an unheated fluid after the drilling mud exits the centrifuge.

The mud cleaning system may include a recirculation system. The recirculation system may recirculate the drilling mud through a separator so that the drilling mud flows through the separator at least twice.

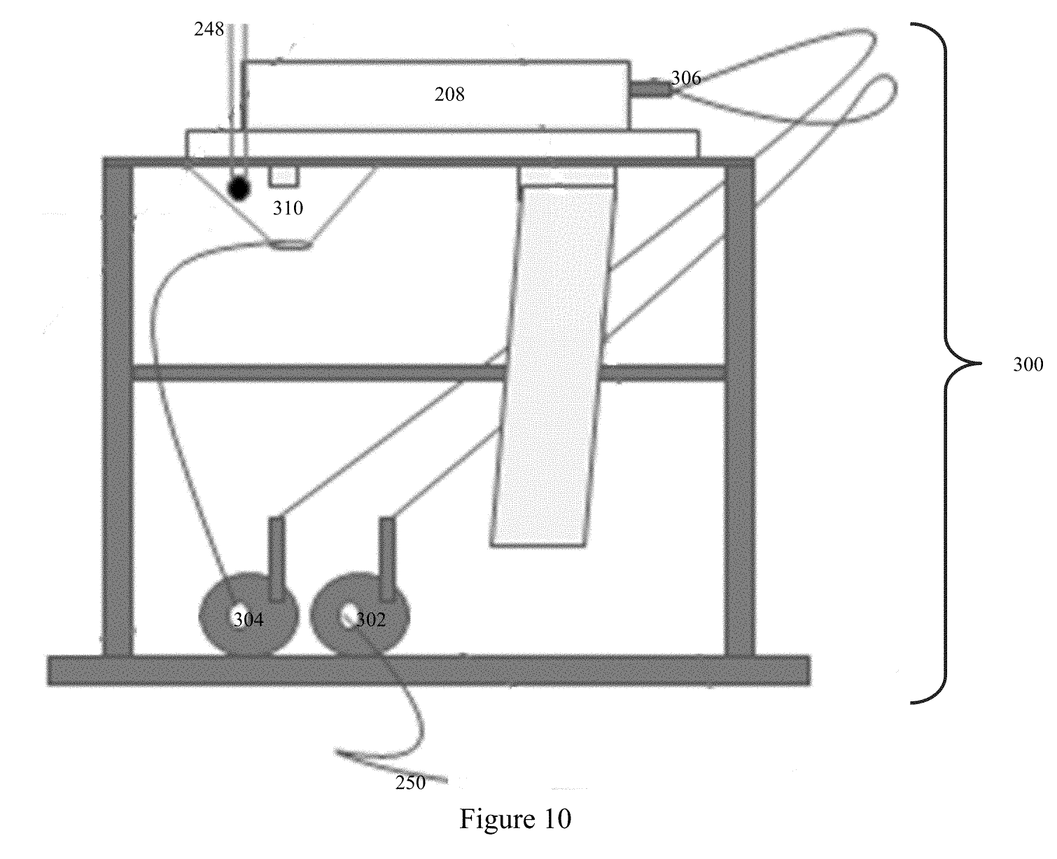

FIG. 10 shows an embodiment of the recirculation system 300 in which the separator is a centrifuge. An inlet of a first pump 302 may be attached to the system inlet 250. An outlet of the first pump 302 may be connected to a first inlet of a Y-adaptor 306. A feed tube of the Y-adaptor 306 may be attached to an inlet of a centrifuge 208. An outlet of the centrifuge 208 may be attached to an inlet of a sump 310. A first outlet of the sump 310 may be attached to an inlet of a second pump 304. A second outlet of the sump 310 may be attached to the system outlet 248. An outlet of the second pump 304 may be attached to a second inlet of the Y-adaptor 306.

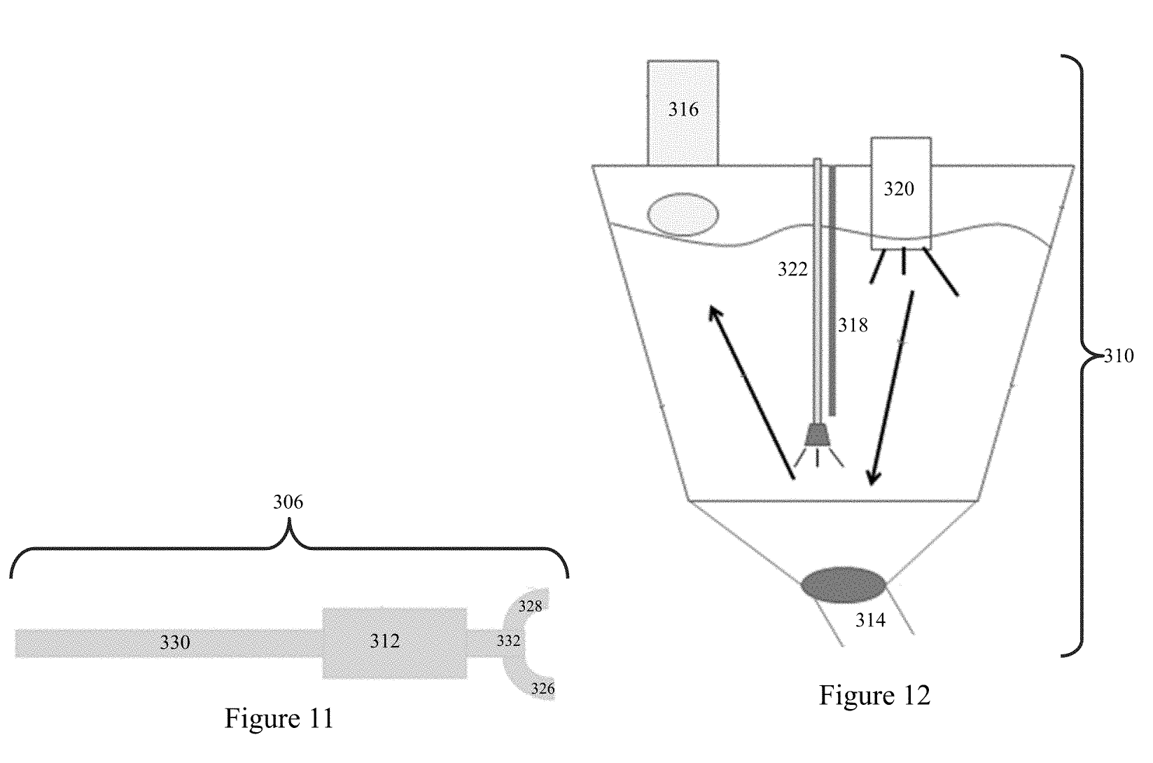

FIG. 11 shows a Y-adapter 306 that may be used in the recirculation system of FIG. 6. Referring to both FIGS. 6 and 7, the recirculation system 300 may pump drilling mud from two sources into the Y-adapter 306. The first pump 302 may pump drilling mud which has not previously been cleaned by the centrifuge 208, i.e., from system inlet 250, into the first inlet 326 of the Y-adapter 306. The second pump 304 may pump drilling mud which has previously been cleaned by the centrifuge 208 into the second inlet 328 of the Y-adapter 306. The drilling mud from these two sources may be mixed in the feed tube 330 of the Y-adapter 306. The feed tube 330 of the Y-adapter 306 may be a shearing feed tube. A shear fitting 332 may connect the first inlet 326 and the second inlet 328 to the feed tube 330. In some embodiments, a heater 312 may be disposed inline with the feed tube 330. The heater 312 may be an inductive heating unit.

FIG. 12 shows a sump 310 that may be used in the recirculation system 300 of FIG. 6. Referring both to FIGS. 6 and 8, drilling mud enters the sump 310 through an inlet 320. The first outlet 314 is disposed at the bottom of the sump 310. The first outlet may use gravity and suction to move drilling mud out of the sump towards the second pump 304. The second outlet 316 is disposed at the top of the sump 310 and connects to the system outlet (not shown). Gravity may ensure that more particulates are in the portion of the drilling mud that exits the sump 310 through the first outlet 314 than through the second outlet 316. The sump 310 may also include a baffle 318. In some embodiments, an additive inlet 322 may be used to inject base oil or other chemicals into the drilling mud in the sump 310. In some embodiments, the sump 310 may be heated. In these embodiments, the mud cleaning system may or may not include another heater. Further, because sump 310 may be an open container that receives the outflow of drilling fluid from the centrifuge (208 in FIG. 4), it is envisioned that sump 310 (and recirculation system) may be retrofitted onto an existing centrifuge, including the incorporation of a heater, such as by attachment of the sump onto an external support structure for centrifuge 208.

The flow of drilling mud through a recirculation system will now be described with reference to FIGS. 10-12. Drilling mud that has not previously been treated by the centrifuge 208 may enter the first pump 302 from the system inlet 250. The first pump 302 may pump the drilling mud into the first inlet 326 of the Y-adapter 306. Drilling mud that has previously been treated by the centrifuge 208 may enter the second pump 304 from the sump 310. The second pump 304 may pump the drilling mud into the second inlet 328 of the Y-adapter 306. The drilling mud that enters the first inlet 326 of the Y-adapter 306 may mix with the drilling mud that enters the second inlet 328 of the Y-adapter 306 in the feed tube 330 of the Y-adapter 306. In some embodiments, a heater 312 may be disposed inline with the feed tube 330 of the Y-adaptor 306. The heater 312 may heat the drilling mud as it flows through the feed tube 330 of the Y-adaptor 306. The mixed drilling mud may flow from the feed tube 330 of the Y-adaptor 306 to the centrifuge 208. After being treated in the centrifuge 208, the drilling mud may enter the sump 310. In some embodiments, the sump 310 may be heated. Drilling mud may exit the sump 310 through a first outlet 314 and a second outlet 316. The first outlet 314 may be disposed at the bottom of the sump 310 and a portion of the drilling mud with more particulates may exit the sump 310 through the first outlet 314 and enter the second pump 304. The second outlet 316 may be disposed at the top of the sump 310 and a portion of the drilling mud with less particulates may exit the sump 310 through the second outlet 316 and flow through the system outlet 248. While this embodiment illustrates a heater 312 that is inline with the feed tube, it is also envisioned that the heater may be located elsewhere, such as along the recirculation line or in the sump 310. In such embodiments, only the recirculated mud may be directly heated by the heater, and the mud that is initially being provided to the centrifuge 208 is only indirectly heated by the recirculated mud.

In one or more embodiments, the centrifuge 208 in a mud cleaning system 200 including a recirculation system 300 may be a high volume polishing centrifuge. The flow rate of drilling mud through the centrifuge 208 may be about 100 gallons per minute. The sump 310 may have a capacity of 160-420 gallons. The first pump 302 may have a feed rate of about 45-50 gallons per minute. The second pump 304 may have a feed rate of about 80 gallons per minute. The pump rate of the sump may be controlled by a variable frequency drive controller. The pump rates of the first pump, the second pump, and the sump may control the number times the drilling mud recirculates through the centrifuge. The recirculation system may be optimized by gradually increasing the pump rate of the sump to the mechanical limit of the centrifuge. The scale of any heating experienced by the drilling mud may depend on the size of the sump.

In a mud cleaning system including a recirculation system, the drilling mud is treated in the centrifuge at least twice. This may increase the total time the drilling mud spends in the centrifuge. The concentration of particulates in the drilling mud at any given time is reduced because a portion of the drilling mud in the centrifuge at any given time has previously been treated at least once by the centrifuge. Thereby, a recirculation system may allow a centrifuge to remove more particulates and smaller particulates from used drilling mud. In an exemplary embodiment, a recirculation system may reduce the diameter of the smallest particles removed by a mud cleaning system from 6 microns to 1.5 microns. A recirculation system may be easier to install and require less space on a drilling rig than additional centrifuges that might achieve a similar effect. A recirculation system may also reduce the time a given amount of drilling mud must be maintained in a mud cleaning system to remove a desired amount and size of particulates. A recirculation system may prevent chemicals from having to be added to the drilling mud to remove particulates, thereby reducing the costs of chemicals and preventing unwanted side-effects of adding chemicals to the drilling mud.

A recirculation system may also be used to recirculate the drilling mud through any separator in the mud cleaning system. The separator may be a shale shaker, a desander, or a desander. Recirculating drilling mud through any separator may present similar advantages to recirculating mud through a centrifuge. In some embodiments of the mud cleaning system, multiple recirculation systems may be used to recirculate the mud through multiple separators. In some embodiments of the mud cleaning system, a single recirculation system may recirculate the mud through multiple separators.

In general, the design of a mud cleaning system including a heat transfer system or a recirculation system may be optimized. A vertical configuration of shell and tube heat exchangers may prevent mud in the heat exchangers from experiencing barite sagging and may keep the mud as homogenous as possible. Any tubes or passageways may have sufficient diameter to limit the risk of plugging by sediments. Flow rates within tubes may be kept high enough to facilitate cleaning and prevent deposition of solid materials on the inner surfaces of the tubes. In some conditions with Binhgam plastic fluid, plug flow may be present and limit heat exchange. Limiting heat exchange may be minimized by having distorted geometry inside the tub to force the flowing plug to enter into contact with the tube wall. For example, the tube may include bends between straight section in the same plane to force the plug to collide with the wall of the tube and force the plug to deform to pass through the bends in the tube. This geometry may still limit the risk of plugging, and cleaning the tube with a brush may still be possible. When mud flows around the pack of tube in a shell and tube heat exchanger, cross-flow may be used because it minimizes the occurrence of plug flow because the fluid continuously experiences different flow geometry. It should be noted that power-Law fluid with n<1, and Bingham plastic fluid exhibit similar velocity profile when in laminar flow. So the optimum design of heat exchanger for Bingham plates may provide good performance with such Power-Law fluid.

Modeling of the geothermal gradient along the depth of a vertical well may be used to determine the effect of pumping mud of a given temperature into a wellbore. Generally, mud will become hotter while moving downwards in the drill string and will cool down when returning to the surface through the annulus. Thus, modeling may be used to predict the mud temperature along the flow path in the well. Modeling of the mud temperature as it is pumped into a well having a geothermal gradient reveals that a change in the initial mud temperature does not translate to the same increase for the temperature of the mud as it exits the well. Rather, for an initial mud temperature of 80 deg F., the mud may return to the surface at 110 deg F. In contrast, by increasing the initial mud temperature to 120 deg F., the mud also returns to the surface at 120 deg F. This modeling may then inform an operator of the desired temperature for mud to be pumped downhole and likewise, for the mud exiting a mud cleaning system. Heating and cooling sections of a heat transfer system may be designed so that mud exits the mud cleaning system at a temperature which produces a desired temperature gradient along the flowpath of the mud in a wellbore having a particular geothermal gradient. The temperature at which mud is pumped into a wellbore may directly affect the temperature of mud which returns to the surface of the wellbore.

The mud cleaning system described in this disclosure may reduce wasted heat that is released to the environment as thermal pollution. The mud cleaning system may reduce the levels of low gravity solids in mud that is pumped into a wellbore during wellbore operations. Reducing the levels of low gravity solids in the mud may improve drilling performance by increasing the rate of production and decreasing the erosion of downhole tools, resulting in a decreased amounted of non-productive time and an increased drilling efficiency. Drilling fluid may have a zeta potential with a higher absolute value at a higher temperature. Thus, the repulsion between charged particles is increased at higher temperatures, preventing agglomeration of particles and preventing sedimentation within the wellbore. Heating the mud may improve the action of chemicals added to the mud while it is being cleaned or processed, before being reused in a wellbore. The mud that has been heated may be passed through a mixer to add chemicals. In some embodiments, rig engine cooling fluid may be able to provide at least about 0.5 megawatts, at least about 0.75 megawatts, or at least about 1 megawatt of heat to the mud. In some embodiments, rig engine exhaust gas may be able to provide about 1.5 megawatts of heat to the mud.

The use of heat to improve mud processing and cleaning may be planned using job modeling, heat transfer modeling, mud process planning, and/or any other type of modeling or planning known in the art. Planning may account for one or more of the following factors: well description, drilling modeling, prediction of engine power versus tasks, mud program definition, heat availability analysis versus tasks and time, impact of hot mud processing on mud cleaning, impact of hot mud processing on action of chemicals added to mud, wellbore flow modeling with heat transfer, verification of the effect of the usage of mud at a given temperature along the wellbore, and analysis of mud cooling, including the use of cold water and the effect of the local climate.

In another aspect, the present disclosure may relate to a method of cleaning drilling mud. The drilling mud may have been used in a downhole operation. The method may include flowing the drilling mud out of a wellbore, heating the drilling mud, and separating particulates from the heated drilling mud in a separator. Particulates may be separated from the heated drilling mud in more than one separator. Each separator may separate particulates of different sizes from the drilling mud. The method may further include monitoring a temperature of the mud with a thermostat control system. The thermostat control system may further be used to control the heat that is transferred to the drilling mud or a property of the separator, such as the rate of flow of the drilling mud through the separator or the rotational speed of the separator. Heating the drilling mud may be performed by transferring heat from at least one rig engine to the drilling mud. Transferring heat from at least one rig engine to the drilling mud may include transferring heat from at least one rig engine to a secondary circuit and transferring heat from the secondary circuit to the drilling mud. However, other heater types with varying locations are also envisioned. Further, the method may further include recirculating the heating drilling mud through a separator a plurality of times. In one or more embodiments, the heater may be included on the recirculation line. That is, for mud making multiple trips through a given separator, the recirculation line may heat the mud being circulated therethrough, which may heat “fresh” drilling mud that is combined therewith in the separator. The method may be performed using a mud cleaning system as described above or using any apparatus or technique known in the art.

In another aspect, this disclosure relates to a method of assembling an enhanced mud cleaning system. A heater and a recirculation system may be attached to a mud cleaning system that includes a separator. The recirculation system may be attached so that the recirculation system feeds the mud output from the separator back into the separator. The heater may be attached so that the heater heats the mud being fed into the separator.

The recirculation system may include a first pump, a second pump, a Y-adapter, and a sump. An outlet of the first pump may be attached to a first inlet of the Y-adaptor. A feed tube of the Y-adaptor may be attached to an inlet of the separator and an inlet of the sump may be attached an outlet of the separator. A first outlet of the sump may be attached to an inlet of the second pump. An outlet of the second pump may be attached to a second inlet of the Y-adaptor. Attaching the recirculation system to the mud cleaning system may include attaching an inlet of the first pump to a system inlet and attaching a second outlet of the sump to a system outlet. These attachments may be made using any technique known in the art.

This method may have the advantage of being able to be used to add a recirculation system to an existing mud cleaning system. The recirculation system may be easy to install and not take up a significant amount of space on a drilling rig. The enhanced mud cleaning system including the recirculation system has only one system outlet, so operation of an enhanced mud cleaning system may be similar to operation of the mud cleaning system prior to the addition of the recirculation system.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. A mud cleaning system comprising:
a system inlet carrying mud from a wellbore;
a heater;
a fluid separating system; and
a system outlet carrying the mud to a holding vessel,
wherein the system inlet, the heater, the separator, and the system outlet are fluidly connected such that mud flows from the system inlet, into the heater and the separator, and then out the system outlet.

2. The mud cleaning system of claim 1, wherein the fluid separating system is selected from the group consisting of a shale shaker, a desilter, a desander, and a centrifuge.

3. The mud cleaning system of claim 1, wherein the heater is a heating element disposed inline with the system inlet and the separator.

4. The mud cleaning system of claim 1, wherein the heater is a heat exchange system comprising:
at least one engine, comprising a pump and a valve for the engine cooling fluid,
at least one heat exchanger, and
a control system,
wherein the heat exchange system transfers heat from the at least one engine to the mud.

5. The mud cleaning system of claim 4, wherein the at least one engine is an engine driving the rig power generator.

6. The mud cleaning system of claim 4, wherein the at least one heat exchanger is a shell and tube heat exchanger, and wherein the mud flows through a vertical tube array and an engine cooling fluid flows through the shell.

7. The mud cleaning system of claim 4, further comprising at least one secondary circuit through which fluid flows,
wherein a first heat exchanger is an engine heat exchanger which transfers heat from an engine cooling fluid to the fluid of the secondary circuit; and
wherein a second heat exchanger is a mud heat exchanger which transfers heat from the fluid of the secondary circuit to the mud.

8. The mud cleaning system of claim 7, wherein the control system comprises:
an engine temperature control process which maintains the temperature of the engine within a desired range by controlling the speed of the pump or actuating the valve to control the flow of the engine cooling fluid;
a cooling fluid control process which maintains the temperature of a cooling fluid that cools the engine within a desired range;
an engine heat exchanger control process which allows heat transfer at the engine heat exchanger only if the engine is above a lower critical temperature;
a mud temperature control process which maintains the temperature of the mud entering the centrifuge by controlling heat transfer at the engine heat exchanger; and
a fluid separation system control process which maintains the separator at the desired speed and maintains the rate of flow of mud through the centrifuge by controlling the speed of a mud pump.

9. The mud cleaning system of claim 8, wherein the engine temperature control process, the secondary circuit control process, the engine heat exchanger control process, the mud temperature control process, and the centrifuge control process are controlled by a single programmable logic controller connected to a main computer of a drilling rig.

10. The mud cleaning system of claim 4, further comprising at least one secondary circuit through which fluid flows, and
wherein a first heat exchanger is an engine heat exchanger which transfers heat from an engine exhaust gas to the fluid of the secondary circuit; and
wherein a second heat exchanger is a mud heat exchanger which transfers heat from the fluid of the secondary circuit to the mud.

11. The mud cleaning system of claim 1, wherein the holding vessel is a mud tank comprising horizontal rails disposed at the top and bottom of the mud tank and rectangular fins disposed between the rails.

12. The mud cleaning system of claim 11, wherein an exterior of the mud tank is made of a first metal and the rectangular fins are made of a second metal.

13. The mud cleaning system of claim 1, further comprising a primary flow pathway and a secondary flow pathway, arranged in parallel between the inlet and the outlet, wherein the heater and the fluid separation system are directly connected to the secondary flow pathway.

14. The mud cleaning system of claim 1, further comprising a radiator, configured to cool the mud, wherein the mud flows through the radiator after flowing through the heater and the fluid separation system.

15. The mud cleaning system of claim 1, further comprising a heat exchanger which transfers heat from mud which has flowed through the heater and the fluid separation system, to mud which has not flowed through the heater or the separator.

16. The mud cleaning system of claim 1, further comprising a heat exchanger which transfers heat from the mud to a reservoir of fluid.

17. The mud cleaning system of claim 1, further comprising a recirculation system.

18. The mud cleaning system of claim 17, wherein the recirculation system comprises:
a first pump, comprising an inlet and an outlet;
a second pump, comprising an inlet and an outlet;
a Y-adapter, comprising a first inlet, a second inlet, and a feed tube; and
a recirculation sump, comprising an inlet, a first outlet, and a second outlet,
wherein the inlet of the first pump is attached to the system inlet and the outlet of the first pump is attached to the first inlet of the Y-adaptor,
wherein the feed tube of the Y-adaptor is attached to an inlet of the separator and the inlet of the sump is attached an outlet of the separator,
wherein the first outlet of the sump is attached to the inlet of the second pump and the second outlet of the sump is attached to the system outlet, and
wherein the outlet of the second pump is attached to the second inlet of the Y-adaptor.

19. The mud cleaning system of claim 18, wherein the heater is an inductive heating unit disposed inline with the feed tube of the Y-adaptor.

20. The mud cleaning system of claim 19, wherein the inductive heating unit comprises a thermostat control system.

21. The mud cleaning system of claim 19, wherein the wherein the first outlet of the recirculation sump is gravity fed.

22. The mud cleaning system of claim 19, wherein a thinning component is injected into the fluid in the recirculation sump.

23. The mud cleaning system of claim 19, wherein the centrifuge is a high volume polishing centrifuge.

24. A method of cleaning drilling mud, the method comprising:
flowing the drilling mud out of a wellbore;
heating the drilling mud; and
separating particulates from the heated drilling mud in a fluid separation system.

25. The method of claim 24, further comprising monitoring a temperature of the mud with a temperature control system.

26. The method of claim 24, further comprising recirculating the heated drilling mud through the fluid separation system a plurality of times.

27. The method of claim 24, wherein the heating comprises transferring heat from at least one rig engine to the drilling mud.

28. The method of claim 24, further comprising cooling the mud after the separating.

29. A method of assembling an enhanced mud cleaning system, the method comprising:
attaching a recirculation system and a heater to a mud cleaning system comprising a fluid separation system,
wherein the recirculation system feeds mud output from the separator back into the fluid separation system, and
wherein the heater heats mud being fed into the fluid separation system.

30. The method of claim 29, wherein the recirculation system comprises:
a first pump, comprising an inlet and an outlet;
a second pump, comprising an inlet and an outlet;
a Y-adapter, comprising a first inlet, a second inlet, and a feed tube; and
a recirculation sump, comprising an inlet, a first outlet, and a second outlet,
wherein the outlet of the first pump is attached to the first inlet of the Y-adaptor,
wherein the feed tube of the Y-adaptor is attached to an inlet of the separator and the inlet of the sump is attached an outlet of the separator,
wherein the first outlet of the sump is attached to the inlet of the second pump, and
wherein the outlet of the second pump is attached to the second inlet of the Y-adaptor, and
wherein attaching the recirculation system to the mud cleaning system comprises attaching the inlet of the first pump to a system inlet and attaching the second outlet of the sump to a system outlet.
